(19) United States
(12) Patent Application Publication
(10) Pub. No.: US 2003/0044562 A1
(43) Pub. Date: Mar. 6, 2003

(54) Disposable absorbent pad for liquid waste collection

(76) Inventors: Grace Li, Franklin Park, NJ (US); Christine M. Monro, Oakland, NJ (US); Ian W. Cottrell, Basking Ridge, NJ (US)

Correspondence Address: GOTTLIEB, RACKMAN & REISMAN, P.C., COUNSELORS AT LAW, 270 MADISON AVENUE, NEW YORK, NY, 10016-0601, US

(21) Appl. No.: 09/945,342

(22) Filed: Aug. 31, 2001

(51) Int. Cl. B32B 3/00; D03D 15/00; D03D 25/00

(52) U.S. Cl. 428/59

(57) ABSTRACT

An improved disposable absorbent article, such as a waste collection pad, is provided. The article or pad includes a liquid permeable top sheet and a liquid impermeable back sheet. The pad also includes an absorbent layer disposed between the top sheet and the back sheet. The absorbent layer exclusively comprises super absorbent polymer, or SAP, granules, which are adhered directly to the back sheet by an adhesive.

### BACKGROUND OF THE INVENTION

This application relates to a waste collection pad, and more particularly to a waste collection pad having improved odor control and liquid retention properties.

Disposable absorbent articles, particularly pads for collecting animal waste, are well known in the art. Typically, such disposable absorbent articles include a liquid-pervious top sheet, a liquid impervious back sheet, and some type of absorbent core interposed between the top sheet and the back sheet. The core must be capable of absorbing and handling significant quantities of fluid like urine or other exudates discharged by the animal.

One material that is often used to construct the core of such pads is water-absorbent resins, which are available in a variety of chemical forms, including substituted and unsubstituted natural and synthetic polymers. Such water-absorbing resins are typically referred to as “super absorbent polymers” or “SAP's,” and typically are lightly cross-linked hydrophilic polymers. SAP's can differ in their chemical identify, but all SAP's are capable of absorbing and retaining amounts of aqueous fluids equivalent to many times their own weight, even when pressure is applied.

Up until now, SAP's have been used as part of the absorbent core of waste collection pads by disbursing or blending them in conventional absorbent fibers, such as cellulosic fibers interspersed with SAP particles. Such a product, however, is less than satisfactory. In the first place, cellulosic fibers, even when interspersed with SAP particles, have modest liquid retention properties, especially under pressure, since the fibers effectively act like a sponge—when pressure is applied, the retained liquid in the sponge-like cellulosic fibers is, at least in part, “squeezed” out. Another problem is that cellulosic fibers do not completely absorb the excreted liquid waste. As a result, the pad top sheet or surface can often get wet, and therefore odor control is less than satisfactory.

Accordingly, it is desirable to provide an improved waste collection pad product which overcomes these disadvantages.

### SUMMARY OF THE INVENTION

Generally speaking, in accordance with the invention, an improved disposable absorbent article, such as a waste collection pad, is provided.

The article or pad includes a liquid permeable top sheet and a liquid impermeable back sheet. The pad also includes an absorbent layer disposed between the top sheet and the back sheet. The absorbent layer preferably comprises only super absorbent polymer (SAP) granules, which are adhered directly to the back sheet by an adhesive. When liquid excrement is applied to the article or pad, the SAP's immediately form a solid gel-like product, thereby preventing leakage. In other words, the SAP's chemically bond with the liquid excrement in order to form a neutralizing salt. As a result, odor is virtually eliminated and liquid absorption is increased. Moreover, the surface of the top sheet is maintained in a dry condition.

Accordingly, it is an object of the invention to provide a disposable absorbent article having improved water absorption properties.

Another object of the invention to provide a disposable absorbent article which is unlikely to leak.

Yet a further object of the invention is to provide a disposable absorbent article which exhibits enhanced odor control.

Still another object of the invention to provide a disposable absorbent article having reduced thickness.

Still other objects and advantages of the invention will in part be obvious, and will in part be apparent, from the following description.

The invention comprises the features of construction, combination of elements and arrangement of parts as described in the following description, and the scope of the invention is indicated in the claims.

### BRIEF DESCRIPTION OF THE DRAWING

For a fuller understanding of the invention, reference is made to the following description taken in connection with the accompanying drawing, in which:

FIG. 1 is a cross-sectional view of a disposable absorbent article or pad made in accordance with the invention.

### DETAILED DESCRIPTION OF THE PREFERRED EMBODIMENT

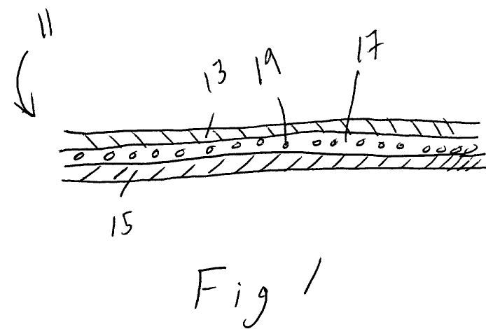

Referring to FIG. 1, a disposable absorbent article or pad made in accordance with the invention, is generally indicated at 11. Pad 11 includes a non-woven liquid permeable top layer 13, a liquid-impervious back sheet 15 and an ultra thin absorbent layer 17 and consisting only of super absorbent polymers or SAP's 19 and bonded to back sheet 15. Back sheet 15 is made of a fluid-impervious film-like material, such as an extruded polyethylene or polypropylene, or the like. Top sheet 13 is made from a wide range of materials such as porous foams, apertured plastic films, woven or non-woven natural fibers such as cotton, synthetic fibers such as polyester or polypropylene fibers, or a combination of natural and synthetic fibers.

In accordance with the invention, the super absorbent polymers are preferably cross-linked sodium polyacrylate. Such super absorbent polymers absorb liquid within 15 to 20 seconds of application. Since cross-linked sodium polyacrylate includes an acid group, the SAP's have the ability to neutralize ammonia (basic) found in urine. As a result, the inventive article or pad has improved odor control properties.

The identity of the SAP's suitable for the present invention is not limited. SAP's are prepared by methods well known in the art, for example, solution or emulsion polymerization. As alluded to above, the preferred SAP is an acidic SAP such as a cross-linked polyacrylic acid. This cross-linked acidic SAP is typically prepared by polymerizing an acidic monomer containing an acyl moiety. Reference is made to PCT Publication No. WO 00/55245.

Even more preferably, the SAP to be used with the inventive article is cross-linked sodium polyacrylate sold under the trade name FLOSORB 200, manufactured by Chemtall of Riceboro, Ga.

Additives may be included in the inventive article or pad such as odor control agents, attractants such as musk and xylene, and fragrances.

The SAP's are adhered directly to the back sheet of the inventive article or pad by means of an adhesive, as described above. Suitable adhesives include organic adhesives, vegetable adhesives and synthetic adhesives. The preferred adhesive is a synthetic adhesive such as thermo-setting adhesives, thermoplastic resins and elastomeric adhesives.

The inventive article or pad is extremely thin, enhancing the ability to package a greater quantity of pads in the same packaging space. The pad preferably has a thickness of between 0.015 and 0.025 inches.

The inventive article of pad will not release absorbed liquid or moisture even under an applied pressure (such as when weight is applied by an animal). This is due to more complete absorption of the liquid by the SAP granules.

Since the SAP's for the inventive pad comprise polymers with an acid group, the ammonia in urine absorbed by the SAP's is neutralized, reducing, if not eliminating, odor. Urine and other liquids are absorbed by the SAP's within seconds of contact as the SAP's start to hydrate and form a gel.

The articles or pads of the invention are typically packaged and sold in a roll, with each pad separable from the roll along a transverse score line. The pads can also be packaged individually.

For use as an animal waste collection pad, the pad of the invention may include double-sided tape or some other sticky surface along the back sheet to ensure that the pad stays in position.

It will thus been seen that the objects set forth above, and those made apparent from the preceding description, are efficiently attained, and since certain changes may be made in the products set forth above without departing from the spirit and scope of the invention, it is intended that all matter contained in the above description shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

1. A disposable absorbent article comprising:
a liquid permeable top sheet;
a liquid impermeable back sheet; and
an absorbent layer disposed between said top sheet and said back sheet and comprising super absorbent polymer granules directly adhered to said back sheet by an adhesive.

2. The article of claim 1, wherein said top sheet comprises a material selected from the group consisting of porous foams, apertured films, natural fibers and plastic synthetic fibers.

3. The article of claim 1, wherein said back sheet comprises a film selected from the group consisting of extruded polyethylene and extruded polypropylene.

4. The article of claim 1, wherein said super absorbent polymer is a cross-linked sodium polyacrylate.

5. The article of claim 1, wherein said super absorbent polymer is an acidic super absorbent polymer.

6. The article of claim 1, wherein said adhesive is selected from the group consisting of organic adhesives, vegetable adhesives and synthetic adhesives.

7. The article of claim 6, wherein said synthetic adhesives are selected from the group consisting of thermo-setting adhesives, thermoplastic resins and elastomeric adhesives.

8. The article of claim 1, wherein the article has a thickness of between about 0.015 and 0.025 inches.

9. A packaged roll of disposable articles comprising a plurality of absorbent pads, selectively separable from one another, each said pad including a liquid-permeable top sheet, a liquid-impermeable back sheet, and an absorbent layer disposed therebetween and defined solely by super absorbent polymer granules directly adhered to said back sheet.

10. The roll of claim 9, wherein said top sheet comprises a material selected from the group consisting of porous foams, apertured films, natural fibers and plastic synthetic fibers.

11. The roll of claim 9, wherein said back sheet comprises a film selected from the group consisting of extruded polyethylene and extruded polypropylene.

12. The roll of claim 9, wherein said super absorbent polymer is a cross-linked sodium polyacrylate.

13. The roll of claim 9, wherein said super absorbent polymer is an acidic super absorbent polymer.

14. The roll of claim 9, wherein said adhesive is selected from the group consisting of organic adhesives, vegetable adhesives and synthetic adhesives.

15. The roll of claim 9, wherein said adhesive is selected from the group consisting of organic adhesives, vegetable adhesives and synthetic adhesives.

16. The roll of claim 15, wherein said synthetic adhesives are selected from the group consisting of thermo-setting adhesives, thermoplastic resins and elastomeric adhesives.

17. The roll of claim 9, wherein said pads are selectively separable from one another along a transverse score line.

18. The roll of claim 9, wherein each pad has a thickness of between about 0.015 and 0.025 inches.
